(19) United States
(12) Patent Application Publication
(10) Pub. No.: US 2026/0119683 A1
(43) Pub. Date: Apr. 30, 2026

(54) DATA MANAGEMENT FOR REGULATORY COMPLIANCE

(71) Applicant: Red Hat, Inc., Raleigh, NC (US)

(72) Inventors: Leigh Griffin, Waterford (IE); Paul Power, Waterford (IE); Anthony Francis Carroll, Waterford (IE)

(73) Assignee: Red Hat, Inc., Raleigh, NC (US)

(21) Appl. No.: 18/930,011

(22) Filed: Oct. 29, 2024

(51) Int. Cl. G06F 21/62

(52) U.S. Cl. CPC G06F 21/62

(57) ABSTRACT

Some examples of the present disclosure relate to deploying configuration files generated from serverless functions. In one particular example, a system can receive a serverless function including a set of software elements. The system can determine resource requirements associated with executing the serverless function. The system can also determine a set of capabilities for a plurality of nodes. The system can generate a set of executable files corresponding to the set of software elements and the resource requirements. The system can assign a first executable file to a first configuration file based on the set of capabilities. The first configuration file is associated with a first node of the plurality of nodes. The system can execute the first configuration file having the first executable file using the first node.

### TECHNICAL FIELD

The present disclosure relates generally to data management. More specifically, but not by way of limitation, this disclosure relates to data management for regulatory compliance.

### BACKGROUND

Distributed computing systems (e.g., cloud computing systems, data grids, and computing clusters) have recently grown in popularity given their ability to improve flexibility, responsiveness, and speed over conventional computing systems. In some cases, the responsiveness and speed of distributed computing systems can be further improved by employing edge-computing solutions. Edge computing is a networking philosophy focused on bringing computing power and data storage as close to the source of the data as possible to reduce latency and bandwidth usage. Distributed computing environments may employ edge devices to perform various functions at the edge. Edge devices may be resource constrained and geographically isolated. One example of edge computing is computing in an automotive environment.

### BRIEF DESCRIPTION OF THE DRAWINGS

FIG. 1 is a block diagram of an example of a system for data management for regulatory compliance according to some examples of the present disclosure.

FIG. 2 is a block diagram of an example of a computing environment for data management for regulatory compliance according to some examples of the present disclosure.

FIG. 3 is a flow chart of an example of a process for data management for regulatory compliance according to some examples of the present disclosure.

### DETAILED DESCRIPTION

A computing system may not be able to control devices that are plugged in or associated with the computing system. As such, the services executed in association with the computing system may not be controlled by the computing system. Data can flow between the services of a computing system, and the computing system may lack control of what data the services are exposing. For example, data being sent by a service may expose a functional endpoint, may expose information within logs that allow an attack vector to learn an endpoint, or may expose a public or private key. As such, privacy data may be exposed to a service that is not intended to have access to the privacy data, leading to security issues for the computing system.

Some examples of the present disclosure can overcome one or more of the abovementioned problems by providing a system that can provide data management for regulatory compliance. In an example, the system can receive a message sent by a first service to a second service prior to the message being received by the second service. The system can compare the message to a set of rules associated with messages between the first service and the second service. The set of rules can be based on a set of regulations associated with a context (e.g., vehicle environment, healthcare system, etc.) of the first service or the second service. The system can modify the message to generate a modified message based on the set of rules. The system can transmit the modified message to the second service and cause an action based on the modified message. Accordingly, the system manages data according to the set of regulations and data privacy standards so that sensitive data is not unintentionally exposed. In addition, the data management can ensure that services are not overloaded with non-critical data, which prevents systems from having to consume compute resources to constantly process non-critical data. As such, security and resource consumption for the system is improved.

As a particular example, a vehicle may be computing environment that includes a first service for braking sensors, a second service for providing music, and a third service for managing vehicle operations that integrates with the braking service and the music service. The braking sensors can send a first message of braking data to the management service at the same time that the music service sends a second message of music data to the management service. An intermediate data-as-a-service (DaaS) module can intercept the messages before they are received by the management service. The DaaS module can lookup rules associated with the services to determine that the first message has a higher priority than the second message, since the braking service can provide critical data related to the functioning of the vehicle. As a result, the DaaS module can process and send the first message prior to processing the second message. Processing the first message can involve comparing the braking data to rules associated with vehicle regulations or other data privacy regulations. Upon comparing the first message to the rules, the DaaS module can determine that the first message includes a private key that is not to be exposed to the management service. So, the DaaS module can modify the braking data to remove the private key from the braking data and then transmit the modified braking data to the management service. As a result of the modified braking data, the management service may perform an action such as causing braking of the vehicle. The DaaS module thus facilitates improved data security and access to provide exposure to relevant services in a more controlled manner.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

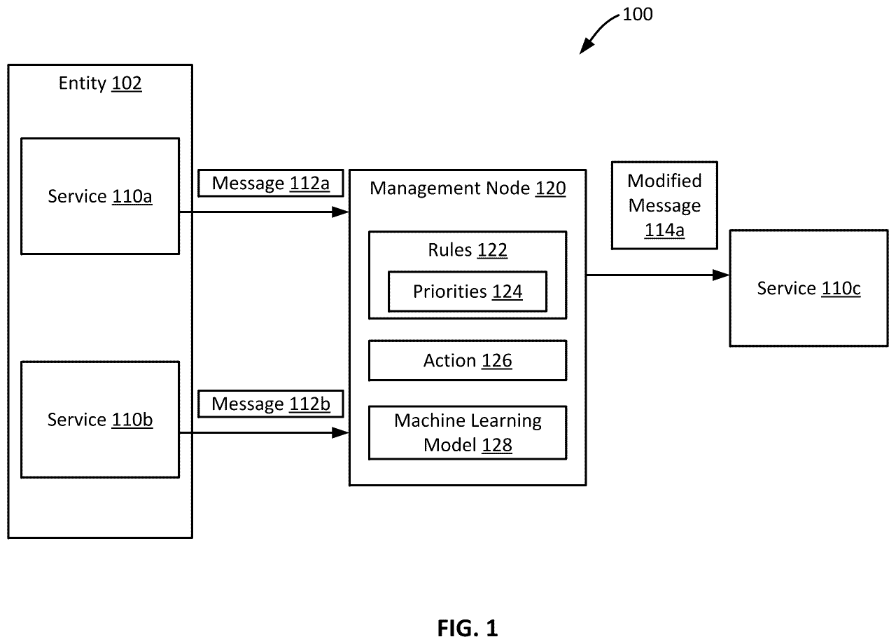

FIG. 1 is a block diagram of an example of a system 100 for data management for regulatory compliance according to some examples of the present disclosure. In some examples, the system 100 may be a distributed computing environment such as an edge computing environment, a cloud computing environment, or a computing cluster. The system 100 can be formed from an entity 102 including services 110a-11b, a management node 120, and an additional service 110c that are in communication with one another via a network, such as a local area network (LAN), wide area network (WAN), the Internet, or any combination thereof. The services 110a-110b can execute on one or more devices (e.g., physical servers, virtual servers, Internet of Things (IoT) devices, etc.) of the entity 102. In addition, the service 110c can execute on a device that may be in a cloud environment or may be within the entity 102.

The system 100 can include the management node 120 that can manage or otherwise communicate with the services 110a-110c. Examples of the management node 120 can include desktop computers, laptop computers, servers, mobile phones, tablets, etc. The management node 120 can be or include a serverless data-as-a-service function that manages how data that is sent between the services 110a-110c is exposed. The services 110a-110b may be part of the entity 102. For instance, the entity 102 may be a vehicle with services for entertainment, automatic braking, log data collection, weather data generation, etc. Other examples of entities include a healthcare management system or any environment with data management requirements.

The management node 120 can receive a message 112a sent by the service 110a to the service 110c. The management node 120 can receive the message 112a prior to the service 110c receiving the message 112a. In this way, the management node 120 intercepts the message 112a from the service 110a. For instance, the message 112a may be sensor data from an automatic braking service that is being sent to a data storage service.

In some examples, the management node 120 compares the message 112a to rules 122. A deployment of the rules 122 may be managed by a software orchestration platform such as Kubernetes or OpenShift. The rules 122 can be associated with messages between the service 110a and the service 110c. That is, the rules 122 may be specific for messages sent between these two services. The rules for other pairs of services (e.g., service 110a and service 110b) may be different than the rules 122 between the service 110a and the service 110c. The rules 122 can be based on a set of regulations associated with a context of the service 110a or the service 110b. For instance, if the entity 102 is a vehicle, then the context is a vehicle environment. If the entity is a healthcare management system, the context may be a healthcare. For a vehicle, the regulations may be functional safety (FuSa) regulations, geographical regulations (e.g., general data protection regulation (GDPR) in Europe), or a combination thereof. So, the rules 122 may be based on a geographic location of the entity 102. For a healthcare management system, the regulations may be health insurance portability and accountability act (HIPAA) regulations.

In some embodiments, the rules 122 may include filters for key words that are to be looked for in the message 112a. The key words may correspond to data that is not to be exposed to other services. For instance, the key words may relate to a functional endpoint (e.g., an application programming interface (API)), information within logs that may allow an attack vector to learn an endpoint, a public key, a private key, etc. A functional endpoint may have its own rules as well, such as rules relating to an automotive safety integrity level (ASIL) for the functional endpoint. The rules for the functional endpoint can be included in the rules 122. So, the key words may be based on the rules for the functional endpoint. Upon detecting a key word indicated in the rules 122, the management node 120 can modify the message 112a to generate a modified message 114a. That is, the management node 120 may remove the data related to the key word from the message 112a to generate the modified message 114a. In this way, the data associated with the key word is not exposed to other services. In some instances, the management node 120 may determine that multiple of the rules 122 are broken, so the management node 120 can determine and implement one or more modifications based on the broken rules.

In addition to indicating key words to look for, the rules 122 may additionally specify a frequency at which the service 110c is to receive messages from the service 110a. For example, the rules 122 may indicate that the service 110c is to receive every tenth message from the service 110a. So, the service 110c may avoid becoming overloaded with messages from the service 110a, thereby reducing a risk of a distributed denial-of-service (DDOS) attack. If the management node 120 determines that the message 112a is not the tenth message, then the management node 120 can avoid sending the message 112a or a modified version of the message 112a to the service 110c.

In some examples, the rules 122 may specify priorities 124 for messages received by various services. For example, the priorities 124 may indicate that messages sent by the service 110a to the service 110c have a higher priority than messages sent by the service 110b to the service 110c. As a particular example, the messages sent by the service 110a may be sensor data from an automatic braking system, while the messages from the service 110b may be weather data from an environmental monitoring system. To ensure that sensor data for braking is processed efficiently (e.g., according to latency standards defined by FuSa standards), the messages sent by the service 110a to the service 110c can have the higher priority than the messages sent by the service 110b to the service 110c.

So, if the management node 120 receives the message 112a from the service 110a for the service 110c substantially contemporaneously (e.g., simultaneously or within a few milliseconds) to receiving message 112b from the service 110b for the service 110c, then the management node 120 can determine that the priority of the service 110a for the message 112a is higher than the priority of the service 110b for the message 112b based on the rules 122. Accordingly, due to the priorities 124, the management node 120 can modify the message 112a prior to comparing the message 112b to rules associated with messages between the service 110b and the service 110c. The rules associated with messages between the service 110b and the service 110c may be different from the rules 122 for messages between the service 110a and the service 110c.

In some examples, upon processing and modifying the message 112a according to the rules 122, the management node 120 can transmit the modified message 114a to the service 110c. Because the modified message 114a has been sanitized to remove sensitive information, the service 110c does not receive or have access to the sensitive information of the message 112a. Accordingly, the sensitive information is not exposed to the service 110c or any other services after the message 112a is modified.

In addition, the management node 120 can cause an action 126 based on the modified message 114a. The action 126 may involve storing the information included in the modified message 114a in a storage system, using the information included in the modified message 114a in downstream processing, causing a presentation of the modified message 114a at a user interface of a device that is executing the service 110c, or any other suitable action. If the service 110c is internal to the entity 102, then the action 126 may involve controlling an operation for the entity 102. For example, if the entity 102 is a vehicle, and the modified message 114a includes sensor data of an automated braking system, then the action 126 can involve causing braking of the vehicle based on the modified message 114a.

In some examples, the management node 120 may use a machine learning model 128 to determine how to handle the message 112a. For instance, the message 112a may be a second or other additional time that the management node 120 has received a message from the service 110a for the service 110c that includes a private key when it shouldn't. Upon detecting a match to a rule for removing the private key multiple times, the management node 120 may generate an input to the machine learning model 128 based on the message 112a. The machine learning model 128 can be trained to determine mitigation operations based on messages. For example, the machine learning model 128 can be trained using training data of messages labeled with rules and associated mitigation operations for the messages (e.g., removing public keys and private keys, removing data associated with a particular geographic location, or removing other sensitive information) to adjust parameters of the machine learning model 128 until a loss function is minimized. So, upon receiving the input based on the message 112a, the management node 120 can receive an output of the machine learning model 128 that indicates the mitigation operation for the service 110a. For example, the mitigation operation may be generating a notification indicating that the service 110a is to me modified so that messages from the service 110a that are being sent to the service 100c do not include a private key. Additionally or alternatively, the mitigation operation may involve recommending a patch or shutting down the service 110a because it is not performing as intended. In some instances, the output of the machine learning model 128 may include multiple recommendations of mitigation operations. The mitigation operations can be staged or graded based on the rules broken. So, the management node 120 can be permissive or strict and apply one or more of the mitigation operations for protection.

In some examples, at some point in time, the management node 120 may determine a change to the service 110a. The change may involve an addition or removal of an integration with another service of the entity 102, a change to a capability of the service 110a, or any other suitable change to the service 110a. As a result of the change, the service 110a may become more or less integral to functioning of the entity 102. For instance, the change may involve the service 110a no longer interacting with an automatic braking system of the entity 102. So, the service 110a may be less critical to the functioning of the entity 102. As a result, the management node 120 can modify the priority of message processing for the messages from the service 110a based on the change. For example, if the change causes the service 110a to become less important than the service 110b to the operation of the entity 102, then the priority of the service 110a may be modified to be lower than the priority of the service 110b, as indicated by the priorities 124.

The service 110a may be a first instance of the service that executes internally to the entity 102. Another entity (e.g., a different vehicle) may include a second instance of the service that executes internally to the other entity and performs the same function as the first instance. The second instance can also send messages to the service 110c that can be processed according to rules by the management node 120. The rules 122 for messages between the service 110a and the service 110c may be different than the rules for messages between the second instance and the service 110c, even though the functionality of the instances is the same. In this way, the rules are entity specific.

While FIG. 1 depicts a specific arrangement of components, other examples can include more components, fewer components, different components, or a different arrangement of the components shown in FIG. 1. For instance, while FIG. 1 only shows two services internal to the entity 102 and one service external to the entity 102, other examples may include a different number of services. In addition, while FIG. 1 shows the management node 120 being external to the entity 102, other examples may include the management node 120 internal to the entity 102. Also, any component or combination of components depicted in FIG. 1 can be used to implement the process(es) described herein.

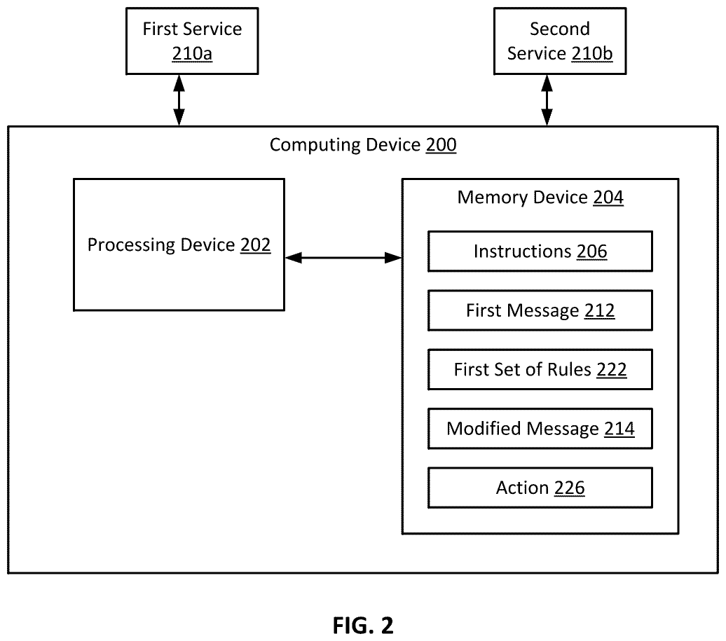

FIG. 2 is a block diagram of an example of a computing device 200 for data management for regulatory compliance according to some examples of the present disclosure. The computing device 200 includes a processing device 202 communicatively coupled to a memory device 204. In some examples, the components of the computing device 200, such as the processing device 202 and the memory device 204, may be part of a same computing device, such as the management node 120 in FIG. 1. In other examples, the processing device 202 and the memory device 204 can be included in separate computing devices that are communicatively coupled.

The processing device 202 can include one processing device or multiple processing devices. Non-limiting examples of the processing device 202 can include a Field-Programmable Gate Array (FPGA), an application-specific integrated circuit (ASIC), and a microprocessor. The processing device 202 can execute instructions 206 stored in the memory device 204 to perform computing operations. In some examples, the instructions 206 can include processor-specific instructions generated by a compiler or an interpreter from code written in any suitable computer-programming language, such as C, C++, C #, etc.

The memory device 204 can include one memory or multiple memories. The memory device 204 can be non-volatile and may include any type of memory that retains stored information when powered off. Non-limiting examples of the memory device 204 include electrically erasable and programmable read-only memory (EEPROM), flash memory, or any other type of non-volatile memory. At least some of the memory device 204 can include a non-transitory computer-readable medium from which the processing device 202 can read instructions 206. A computer-readable medium can include electronic, optical, magnetic, or other storage devices capable of providing the processing device 202 with computer-readable instructions or other program code. Non-limiting examples of a computer-readable medium include magnetic disk(s), memory chip(s), ROM, random-access memory (RAM), an ASIC, a configured processor, optical storage, or any other medium from which a computer processor can read the instructions 206.

In some examples, the processing device 202 can execute the instructions 206 to perform some or all of the functionality described herein. For example, the processing device 202 can receive a first message 212 sent by a first service 210a to a second service 210b prior to the first message 212 being received by the second service 210b. The processing device 202 can compare the first message 212 to a first set of rules 222 associated with first messages between the first service 210a and the second service 210b. The first set of rules 222 are based on a set of regulations associated with a context of the first service 210a or the second service 210b. The processing device 202 can modify the first message 212 to generate a modified message 214 based on the first set of rules 222. The processing device 202 can transmit the modified message 214 to the second service 210b and cause an action 226 based on the modified message 214. Accordingly, the management node 120 manages data according to the set of regulations and data privacy standards so that data is not unintentionally exposed. In addition, the data management can ensure that services are not overloaded with non-critical data, which shields systems from having to consume compute resources to constantly process non-critical data.

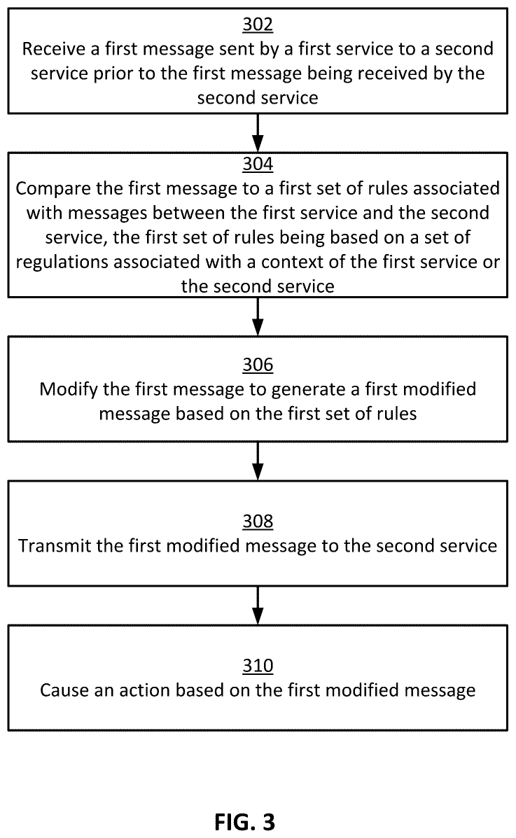

FIG. 3 is a flow chart of an example of a process for data management for regulatory compliance according to some examples of the present disclosure. In some examples, the processing device 202 can implement some or all of the steps shown in FIG. 3. Additionally, in some examples, the processing device 202 can be executing on or in communication with the management node 120 of FIG. 1 to implement some or all of the steps shown in FIG. 3. Other examples can include more steps, fewer steps, different steps, or a different order of the steps than is shown in FIG. 3. The steps of FIG. 3 are discussed below with reference to the components discussed above in relation to FIGS. 1-2.

At block 302, the processing device 202 can receive a first message 212 sent by a first service 210a to a second service 210b prior to the first message 212 being received by the second service 210b. the processing device 202 intercepts the first message 212 from the first service 210a before the second service 210b receives the first message 212. The first message 212 can include data generated or collected by the first service 210a.

At block 304, the processing device 202 can compare the first message 212 to a first set of rules 222 associated with first messages between the first service 210a and the second service 210b. The first set of rules 222 are based on a set of regulations associated with a context of the first service 210a or the second service 210b. For instance, the first service 210a or the second service 210b may execute within a vehicle context, so the set of regulations may be FuSa regulations. The first set of rules 222 may be specified by user input received by or accessible to the processing device 202 or may be generated by a machine learning model based on the first service 210a, the second service 210b, the context of the first service 210a or the second service 210b, and the set of regulations. The first set of rules 222 may include filters for key words that are to be looked for in the message 212a. The rules 222 may additionally specify a frequency at which the second service 210b is to receive messages from the first service 210a. In addition, the first set of rules 222 can specify priorities for messages sent and received by various services.

At block 306, the processing device 202 can modify the first message 212 to generate a modified message 214 based on the first set of rules 222. Generating the modified message 214 can involve the processing device 202 removing data related to a key word indicated in the first set of rules 222 from the first message 212. To comply with a specified frequency at which the second service 210b is to receive messages from the first service 210a, then the processing device 202 can avoid sending the first message 212 or the modified message 214 to the second service 210b. As such, privacy data may not be exposed and the second service 210b can be prevented from becoming overloaded.

At block 308, the processing device 202 can transmit the modified message 214 to the second service 210b. The second service 210b does not receive or have access to the sensitive information of the first message 212, so the sensitive information is not exposed to the second service 210b.

At block 310, the processing device 202 can cause an action 226 based on the modified message 214. The action 226 may involve the second service 210b storing the information included in the modified message 214, using the information included in the modified message 214 in downstream processing, causing a presentation of the modified message 214 at a user interface of a device that is executing the second service 210b, controlling an action of an entity executing the first service 210a or the second service 210b, or any other suitable action.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

1. A system comprising:
a processing device; and
a memory device including instructions that are executable by the processing device for causing the processing device to perform operations comprising:
receiving a first message sent by a first service to a second service prior to the first message being received by the second service;
comparing the first message to a first set of rules associated with first messages between the first service and the second service, the first set of rules being based on a set of regulations associated with a context of the first service or the second service;
modifying the first message to generate a modified message based on the first set of rules;
transmitting the modified message to the second service; and
causing an action based on the modified message.

2. The system of claim 1, wherein the operations further comprise:
receiving a second message sent by a third service to the second service substantially contemporaneously with receiving the first message and prior to the second message being received by the second service;
determining that a first priority of the first service is higher than a second priority of the third service; and
modifying the first message prior to comparing the second message to a second set of rules associated with second messages between the third service and the second service based on the first priority being higher than the second priority.

3. The system of claim 1, wherein the operations further comprise:
determining a change to the first service; and
modifying a priority of message processing for the first messages from the first service based on the change, the priority indicated in the first set of rules.

4. The system of claim 1, wherein the operations further comprise:
generating an input to a machine learning model based on the first message; and
receiving an output of the machine learning model based on the input, the output indicating a mitigation operation for the first service.

5. The system of claim 1, wherein the first set of rules indicate a frequency at which the second service is to receive the first messages from the first service.

6. The system of claim 1, wherein a first instance of the first service executes internally to a first entity and the second service executes externally to the first entity, the first set of rules associated with the first messages between the first instance of the first service and the second service being different from a second set of rules associated with second messages between a second instance of the first service and the second service, wherein the second instance executes internally to a second entity.

7. The system of claim 1, wherein the context comprises a vehicle environment and the set of regulations comprise automotive functional safety regulations.

8. A method comprising:
receiving a first message sent by a first service to a second service prior to the first message being received by the second service;
comparing the first message to a first set of rules associated with first messages between the first service and the second service, the first set of rules being based on a set of regulations associated with a context of the first service or the second service;
modifying the first message to generate a modified message based on the first set of rules;
transmitting the modified message to the second service; and
causing an action based on the modified message.

9. The method of claim 8, further comprising:
receiving a second message sent by a third service to the second service substantially contemporaneously with receiving the first message and prior to the second message being received by the second service;
determining that a first priority of the first service is higher than a second priority of the third service; and
modifying the first message prior to comparing the second message to a second set of rules associated with second messages between the third service and the second service based on the first priority being higher than the second priority.

10. The method of claim 8, further comprising:
determining a change to the first service; and
modifying a priority of message processing for the first messages from the first service based on the change, the priority indicated in the first set of rules.

11. The method of claim 8, further comprising:
generating an input to a machine learning model based on the first message; and
receiving an output of the machine learning model based on the input, the output indicating a mitigation operation for the first service.

12. The method of claim 8, wherein the first set of rules indicate a frequency at which the second service is to receive the first messages from the first service.

13. The method of claim 8, wherein a first instance of the first service executes internally to a first entity and the second service executes externally to the first entity, the first set of rules associated with the first messages between the first instance of the first service and the second service being different from a second set of rules associated with second messages between a second instance of the first service and the second service, wherein the second instance executes internally to a second entity.

14. The method of claim 8, wherein the context comprises a vehicle environment and the set of regulations comprise automotive functional safety regulations.

15. A non-transitory computer-readable medium comprising program code that is executable by a processor for causing the processor to perform operations including:
receiving a first message sent by a first service to a second service prior to the first message being received by the second service;
comparing the first message to a first set of rules associated with first messages between the first service and the second service, the first set of rules being based on a set of regulations associated with a context of the first service or the second service;
modifying the first message to generate a modified message based on the first set of rules;
transmitting the modified message to the second service; and
causing an action based on the modified message.

16. The non-transitory computer-readable medium of claim 15, wherein the operations further comprise:
receiving a second message sent by a third service to the second service substantially contemporaneously with receiving the first message and prior to the second message being received by the second service;
determining that a first priority of the first service is higher than a second priority of the third service; and
modifying the first message prior to comparing the second message to a second set of rules associated with second messages between the third service and the second service based on the first priority being higher than the second priority.

17. The non-transitory computer-readable medium of claim 15, wherein the operations further comprise:
determining a change to the first service; and
modifying a priority of message processing for the first messages from the first service based on the change, the priority indicated in the first set of rules.

18. The non-transitory computer-readable medium of claim 15, wherein the operations further comprise:
generating an input to a machine learning model based on the first message; and
receiving an output of the machine learning model based on the input, the output indicating a mitigation operation for the first service.

19. The non-transitory computer-readable medium of claim 15, wherein the first set of rules indicate a frequency at which the second service is to receive the first messages from the first service.

20. The non-transitory computer-readable medium of claim 15, wherein a first instance of the first service executes internally to a first entity and the second service executes externally to the first entity, the first set of rules associated with the first messages between the first instance of the first service and the second service being different from a second set of rules associated with second messages between a second instance of the first service and the second service, wherein the second instance executes internally to a second entity.
